(19) United States
(12) Patent Application Publication
(10) Pub. No.: US 2010/0288807 A1
(43) Pub. Date: Nov. 18, 2010

(54) DEEP DRAW CAP FOR ROOF RACK

(75) Inventors: Reinhard Neu, Solingen (DE); Kurt Koch, Quierschied (DE)

Correspondence Address: HARNESS, DICKEY & PIERCE, P.L.C., P.O. BOX 828, BLOOMFIELD HILLS, MI, 48303, US

(73) Assignee: Hans und Ottmar Binder GMBH OBerflachenveredelung, Boehmenkirch (DE)

(21) Appl. No.: 12/812,366

(22) PCT Filed: Dec. 13, 2008
(86) PCT No.: PCT/EP2008/010623

§ 371 Date: Jul. 9, 2010

(30) Foreign Application Priority Data
Jan. 11, 2008 (DE) 102008004967.0

(51) Int. Cl. B60R 9/04

(52) U.S. Cl. 224/309

(57) ABSTRACT

The invention relates to a roof rack for a vehicle, having at least one longitudinal beam that is connected with at least one separate support foot. It is provided that the support foot has a base body provided with attachment elements, which base body is covered by a visual cover that also covers the attachment elements.

The invention relates to a roof rack for vehicles, consisting of preferably two longitudinal, particularly tubular, beams, which are disposed at a distance from and essentially parallel to the roof surface, extending along the lateral roof frames, and of support feet that carry the longitudinal beams, which are supported on the roof or in channels formed in it.

Such roof racks are described in various patent documents. As is evident from these documents, a roof rack usually consists of at least one tubular (profiled) longitudinal beam—rack rod—on each roof side and two or more support feet that carry a tubular longitudinal beam, in each instance. For assembly, the longitudinal beam and the support feet are connected at the ends of the longitudinal beam. The support feet are equipped with threaded bolts, screws, or the like, whose projecting ends are passed through bores in the roof sheet metal. Nuts are applied to the threaded bolts from the other side of the roof sheet metal.

In general, the longitudinal beams consist of aluminum tubes, but can also be produced from steel tubes, and are bent in two or three planes, corresponding to the roof contour. The support feet are produced separately, as injection-molded plastic parts or cast metal parts, in some cases also as forged parts.

With regard to the surfaces, the components must be coordinated with one another in terms of color and degree of shine. This can be done by means of painting, powder-coating, chrome-plating, or anodizing. In the case of higher-quality vehicles, highly decorative surfaces such as those produced by means of chrome-plating or anodizing are frequently required.

However, these metallic, highly decorative surfaces cannot be achieved with every material. For example, support feet made of plastic can only be painted and chrome-plated; support feet made of cast metal can only be powder-coated, painted, and chrome-plated. An adaptation of these components to anodized surfaces of longitudinal beams made of aluminum is not possible.

It is furthermore disadvantageous in connection with the roof racks described above that they can fundamentally be screwed onto the roof only from the inside of the roof sheet metal, and this is not always possible or desirable in the case of all vehicle types.

The invention is therefore based on the task of proposing a roof rack for vehicles having a longitudinal beam carried by supports, which rack can be installed on a vehicle roof from the outside, but also from the inside, if pre-installed attachment bolts (screws) are present, and the longitudinal beams and support feet of which rack guarantee a uniform design with regard to a highly decorative surface and its appearance. Specifically in the case of anodized surfaces.

Proceeding from this stated task, a roof rack for vehicles, of the type mentioned initially, is proposed, in which the roof rack can be screwed onto a roof from the outside or the inside. Where the support feet that are inserted into the longitudinal beams by way of tabs are covered, after installation on the vehicle, in the case of installation from the outside, by means of a cap that is produced from an aluminum sheet, using the deep-drawing method. In the case of roof racks to be installed from the inside of the roof, the cap is installed first.

Since the longitudinal beams and the caps consist of the same aluminum material, their surfaces can be treated in the same manner and produce a uniform surface quality and a uniform surface appearance, particularly in the case of parts to be anodized.

The supports—base bodies—that are pre-assembled by being inserted into the longitudinal beams with tabs are screwed onto the roof of the vehicle from the outside, and afterwards, the aluminum cap described above is clipped onto every support. In the case of installation on the vehicle from the inside, the cap can also be already pre-assembled on the supports.

In order to be able to connect the aluminum cap with the base body, the support, a plastic insert is introduced into the aluminum cap, on which insert corresponding clips and guides are provided, which are guided and/or clipped into corresponding accommodations on the support, in order to guarantee secure hold of the cap on the base body.

The connection of the aluminum cap to the plastic insert is achieved by means of gluing with liquid or paste-like adhesives. A connection of the two components with adhesive films or adhesive elements made from double-sided adhesive foam strips is also possible.

The plastic insert is adapted to the interior contour of the cap, and has corresponding surfaces on which gluing to the cap is possible and planned. Also, corresponding depressions can be provided in the plastic insert, in order to use adhesive strips or adhesive films that are inserted into these depressions for gluing.

The supports for such a rack can be produced as plastic injection-molded parts or as metal cast parts. The corresponding accommodations for clipping on the cap are introduced into these supports. For reasons of weight savings, the support and the plastic insert can be structured using a skeletal construction. The clips and the guides on the cap and the support are designed in such a manner that rattle-free and firm seating of the caps on the feet is possible.

It is also possible to insert the aluminum caps into a plastic injection-molding mold after production, and to injection-mold the plastic insert described above into them. For this purpose, the caps must first be treated with corresponding adhesion-imparting agents or the like.

Another possibility is injection-molding a plastic behind an anodized aluminum foil, where the injection-molded plastic corresponds to the plastic insert described above, in terms of its function, clips, guides, etc. The aluminum foil is first stamped to form the correct shape, in a stamping process, laid into an injection-molding mold, and the plastic is injection-molded behind it.

The advantage of the two possibilities mentioned last, injection-molding of the plastic insert into the cap and injection-molding of a plastic carrier behind a foil, is that gluing the two components together, as an additional work step, is eliminated. After the cap is removed from the injection-molding mold, the cap is finished as a component, in both cases.

The invention will be described in greater detail below in the following, using the figures.

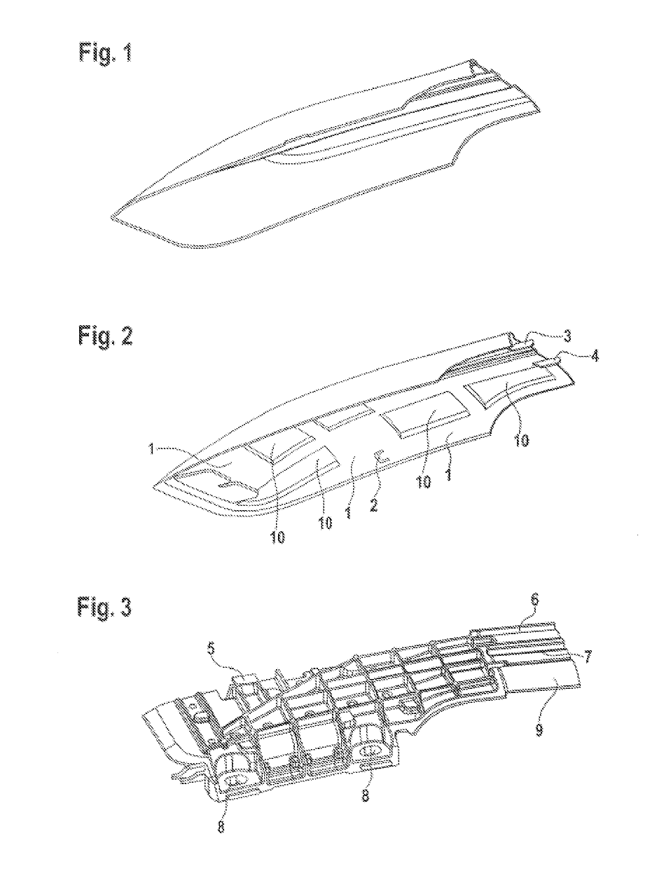

FIG. 1 shows a perspective representation of the cover cap made of aluminum,

FIG. 2 shows a perspective representation of the plastic insert,

FIG. 3 shows a perspective representation of the support (base body).

In the representation in FIG. 1, the aluminum deep-drawn cap can be seen, which can be structured as an assembled cap. The cap is glued to the plastic insert FIG. 2 by way of the adhesive surfaces 1 described.

The plastic insert can be seen in the representation in FIG. 2. On the plastic insert FIG. 2, the clips 2 and guides 3 and 4 that are required for later assembly of the assembled cap, joined together by gluing FIG. 1 and FIG. 2, can be seen; these are required for installation of the assembled cap on the support foot FIG. 3. The clips and guides can be structured differently, depending on the shape of the components. The plastic insert FIG. 2 can be structured in a skeletal shape—framework structure, in order to reduce weight; for this purpose, open windows 10 are formed in the component.

In the representation in FIG. 3, the support foot can be seen. The accommodations 5 for the clips 2 and the accommodations 6 and 7 for the guides 3 and 4 of the plastic insert FIG. 2 can be seen on the support foot FIG. 3.

The support foot FIG. 3 is later covered, by means of pushing on and/or clipping on the assembled cap, over the clips and guides, after installation of the rack on the vehicle, so that a support foot unit is formed, in which no screws or attachment bolts are visible from the outside.

The complete rack, formed by at least two supports, front support and rear support, and a rack rod that connects the supports, made of a hollow profile, is first screwed onto the vehicle roof from the outside, by way of the holes 8 in the support foot, on the vehicle roof. The connection of the supports with the rack rod takes place first, by way of the tabs 9 of the support FIG. 3. After the rack has been screwed onto the vehicle roof, the assembled cap is clipped onto the support feet FIG. 3 as described above; in this connection, the guides 3 and 4 of the plastic insert are pushed into the guides 6 and 7 of the tab, and are held by the rack rod, so that the assembled cap is permanently attached here. The guides 3 and 4 are produced in such a manner that they are always held in the rack profile under bias, in order to prevent rattling and loosening of the cap.

In the case of rack installation on the vehicle by means of screwing the rack on from the inside, the support feet FIG. 3, which were first connected with the rack rod to form a rack, are also already provided with screws or attachment bolts in the supports FIG. 3. The assembled cap is also pre-assembled on the support, where also, the screws or attachment bolts are covered by the cap. The rack is then screwed onto the vehicle from the inside, without any additional work steps.

As has already been described, the aluminum cap FIG. 1 is glued to the plastic insert FIG. 2 to form a unit.

When the plastic carrier FIG. 2 is injection-molded into an aluminum deep-drawn part FIG. 1, the work step of gluing is eliminated; the parts form a unit after they are removed from the mold. The same holds true for injection-molding the plastic carrier part FIG. 2 behind an aluminum foil, similar to FIG. 1.

Preferably, perforations for attachment screws/attachment bolts are used as attachment elements. In addition or alternatively, threaded bores for attachment screws are also possible as attachment elements. The visual cover is preferably structured as a cap (FIG. 1), particularly an aluminum deep-drawn cap or assembled cap. A plastic insert (FIG. 2) can be used as an attachment insert. Clips 2 are used as clip elements, to the extent that these are present.

1-11. (canceled)

12. A roof rack for a vehicle, comprising:
at least one longitudinal beam;
at least one separate support foot connected with the at least one longitudinal beam, the support foot having a base body provided with attachment elements, the base body covered by a visual cover that also covers the attachment elements; and
an attachment insert disposed between base body and visual cover for holding the visual cover on the base body, the attachment insert being injection-molded onto the visual cover.

13. The roof rack according to claim 12, wherein the visual cover is constructed of aluminum or an aluminum alloy.

14. The roof rack according to claim 12, wherein the longitudinal beam is constructed of aluminum or an aluminum alloy.

15. The roof rack according to claim 12, wherein the visual cover has a cap shape.

16. The roof rack according to claim 12, wherein the visual cover is a deep-drawn part.

17. The roof rack according to claim 12, wherein the attachment insert is a plastic part.

18. The roof rack according to claim 12, wherein the attachment insert has clip elements for a clip connection with the base body and/or the visual cover.

19. The roof rack according to claim 12, wherein the attachment insert is glued to the base body and/or the visual cover.

20. The roof rack according to claim 12, wherein the visual cover is glued to the base body.

21. The roof rack according to claim 12, wherein the visual cover is formed by an aluminum foil, an aluminum alloy foil, an aluminum sheet, or an aluminum alloy sheet.

22. The roof rack according to claim 12, wherein the attachment insert forms a support part for the visual cover.

23. The roof rack according to claim 12, wherein the attachment insert forms a mechanical reinforcing part for the visual cover.
